(19) United States
(12) Patent Application Publication
(10) Pub. No.: US 2013/0189529 A1
(43) Pub. Date: Jul. 25, 2013

(54) MITIGATION AND CONTROL OF ALUMINOSILICATE SCALE THROUGH A NOVEL FEEDING STRATEGY OF THE INHIBITOR

(71) Applicant: Nalco Company, Naperville, IL (US)

(72) Inventors: John D. Kildea, Baldivis (AU); Timothy La, Kardinya (AU); Heinrich E. Bode, Aurora, IL (US)

(73) Assignee: NALCO COMPANY, Naperville, IL (US)

(21) Appl. No.: 13/791,577

(22) Filed: Mar. 8, 2013

Related U.S. Application Data
(63) Continuation-in-part of application No. 12/567,116, filed on Sep. 25, 2009.

(51) Int. Cl. C09K 15/20

(52) U.S. Cl. CPC C09K 15/20
USPC 428/446

(57) ABSTRACT

The invention provides a method of inhibiting the accumulation of DSP scale in the liquor circuit of Bayer process equipment. The method includes pre-treating surfaces of the process equipment with one or more particular silane based small molecules. These scale inhibitors reduce DSP scale formation and thereby increase fluid throughput, increase the amount of time Bayer process equipment can be operational and reduce the need for expensive and dangerous acid washes of Bayer process equipment. As a result, the invention provides a significant reduction in the total cost of operating a Bayer process.

### CROSS-REFERENCE TO RELATED APPLICATIONS

This application is a continuation in part of pending application Ser. No. 12/567,116 filed on Sep. 25, 2009.

### STATEMENT REGARDING FEDERALLY SPONSORED RESEARCH OR DEVELOPMENT

Not Applicable.

### BACKGROUND OF THE INVENTION

This invention relates to compositions of matter and methods of using them to treat scale in various industrial process streams, in particular certain silane based small molecules that have been found to be particularly effective in treating aluminosilicate scale in a Bayer process stream.

As described among other places in U.S. Pat. No. 6,814,873 the contents of which are incorporated by reference in their entirety, the Bayer process is used to manufacture alumina from Bauxite ore. The process uses caustic solution to extract soluble alumina values from the bauxite. After dissolution of the alumina values from the bauxite and removal of insoluble waste material from the process stream the soluble alumina is precipitated as solid alumina trihydrate. The remaining caustic solution known as “liquor” and/or “spent liquor” is then recycled back to earlier stages in the process and is used to treat fresh bauxite. It thus forms a fluid circuit. For the purposes of this application, this description defines the term “liquor”. The recycling of liquor within the fluid circuit however has its own complexities.

Bauxite often contains silica in various forms and amounts. Some of the silica is unreactive so it does not dissolve and remains as solid material within the Bayer circuit. Other forms of silica (for example clays) are reactive and dissolve in caustic when added into Bayer process liquors, thus increasing the silica concentration in the liquor. As liquor flows repeatedly through the circuit of the Bayer process, the concentration of silica in the liquor further increases, eventually to a point where it reacts with aluminum and soda to form insoluble aluminosilicate particles. Aluminosilicate solid is observed in at least two forms, sodalite and cancrinite. These and other forms of aluminosilicate are commonly referred to, and for the purposes of this application define, the terms “desilication product” or “DSP”.

DSP can have a formula of 3(Na₂O.Al₂O₃.2SiO₂.0-2H₂O).2NaX where X represents OH⁻, Cl⁻, CO₃²⁻, SO₄²⁻. Because precipitation of DSP increases at higher temperatures and it can precipitate as fine scales of hard insoluble crystalline solids, its accumulation in Bayer process equipment is problematic. As DSP accumulates in Bayer process pipes, vessels, heat transfer equipment, and other process equipment, it forms flow bottlenecks and obstructions and can adversely affect liquor throughput. In addition because of its thermal conductivity properties, DSP scales on heat exchanger surfaces reduce the efficiency of heat exchangers.

These adverse effects are typically managed through a descaling regime, which involves process equipment being taken off line and the scale being physically or chemically treated and removed. A consequence of this type of regime is significant and results in regular periods of down-time for critical equipment. Additionally as part of the descaling process the use of hazardous concentrated acids such as sulfuric acid are often employed and this constitutes an undesirable safety hazard.

Another way Bayer process operators manage the buildup of silica concentration in the liquor is to deliberately precipitate DSP as free crystals rather than as scale. Typically a “desilication” step in the Bayer process is used to reduce the concentration of silica in solution by precipitation of silica as DSP, as a free precipitate. While such desilication reduces the overall silica concentration within the liquor, total elimination of all silica from solution is impractical and changing process conditions within various parts of the circuit (for example within heat exchangers) can lead to changes in the solubility of DSP, resulting in consequent precipitation as scale.

Previous attempts at controlling and/or reducing DSP scale in the Bayer process have included adding polymer materials containing three alkyloxy groups bonded to one silicon atom as described in U.S. Pat. No. 6,814,873 B2, US published applications 2004/0162406 A1, 2004/0011744 A1, 2005/0010008 A2, international published application WO 2008/045677 A1, and published article Max HT™ Sodalite Scale Inhibitor: Plant Experience and Impact on the Process, by Donald Spitzer et. al., Pages 57-62, Light Metals 2008, (2008) all of whose contents are incorporated by reference in their entirety.

Manufacturing and use of these trialkoxysilane-grafted polymers however can involve unwanted degrees of viscosity, making handling and dispersion of the polymer through the Bayer process liquor problematic. Other previous attempts to address foulant buildup are described in U.S. Pat. Nos. 5,650,072 and 5,314,626 both of which are incorporated by reference in their entirety.

Thus while a range of methods are available to Bayer process operators to manage and control DSP scale formation, there is a clear need for, and utility in, an improved method of preventing or reducing DSP scale formation on Bayer process equipment. The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

At least one embodiment is directed towards a method for reducing siliceous scale in a Bayer process comprising the step of adding to a fluid in contact with one or more surfaces of Bayer process equipment an aluminosilicate scale inhibiting amount of reaction product between an amine-containing molecule and an amine-reactive molecule containing at least one amine-reactive group per molecule and at least one —Si(OR) group per molecule, where n=1, 2, or 3, and R=H, C1-C12 Alkyl, Aryl, Na, K, Li, or NH₄, or a mixture of such reaction products. This composition can be added both to Bayer liquor as well as to liquid which does not contain any Bayer liquor but which is passing through process equipment of a Bayer process.

Another embodiment is directed towards a method for reducing siliceous scale in a Bayer process comprising the step of adding to a Bayer process equipment an efficacious amount of reaction product between: 1) an amine-containing small molecule, and 2) an amine-reactive small molecule containing at least one amine-reactive group per molecule and at least one —Si(OR)ₙ group per molecule, where n=1, 2, or 3, and R=H, C1-C12 Alkyl, Aryl, Na, K, Li, or NH₄, or a mixture of such reaction products, and 3) a non-polymeric amine reactive hydrophobic hydrocarbon.

At least one embodiment is directed towards a method of reducing DSP in a Bayer process comprising the step of adding to the Bayer process stream an aluminosilicate scale inhibiting amount of a mixture of products as defined above.

### BRIEF DESCRIPTION OF THE DRAWINGS

A detailed description of the invention is hereafter described with specific reference being made to the drawings in which:

FIG. 1 is a graph illustrating the average total mass of solids recovered using the inventive method.

FIG. 2 is a graph illustrating the net mass of solids recovered using the inventive method.

FIG. 3 is a graph illustrating the net mass of DSP recovered plotted as a function of treatment using the inventive method.

For the purposes of this disclosure, like reference numerals in the figures shall refer to like features unless otherwise indicated. The drawings are only an exemplification of the principles of the invention and are not intended to limit the invention to the particular embodiments illustrated.

### DETAILED DESCRIPTION OF THE INVENTION

For purposes of this application the definition of these terms is as follows:

“Polymer” means a chemical compound comprising essentially repeating structural units each containing two or more atoms. While many polymers have large molecular weights of greater than 500, some polymers such as polyethylene can have molecular weights of less than 500. Polymer includes copolymers and homo polymers.

“Small molecule” means a chemical compound comprising essentially non-repeating structural units. Because an oligomer (with more than 10 repeating units) and a polymer are essentially comprised of repeating structural units, they are not small molecules. Small molecules can have molecular weights above and below 500. The terms “small molecule” and “polymer” are mutually exclusive.

“Foulant” means a material deposit that accumulates on equipment during the operation of a manufacturing and/or chemical process which may be unwanted and which may impair the cost and/or efficiency of the process. DSP is a type of foulant.

“Amine” means a molecule containing one or more nitrogen atoms and having at least one secondary amine or primary amine group. By this definition, monoamines such as dodecylamine, diamines such as hexanediamine, and triamines such as diethylenetriamine, are all amines.

“GPS” is 3-glycidoxypropyltrimethoxysilane.

“Alkyloxy” means having the structure of OX where X is a hydrocarbon and O is oxygen. It can also be used interchangeably with the term “alkoxy”. Typically in this application, the oxygen is bonded both to the X group as well as to a silicon atom of the small molecule. When X is C₁ the alkyloxy group consists of a methyl group bonded to the oxygen atom. When X is C₂ the alkyloxy group consists of an ethyl group bonded to the oxygen atom. When X is C₃ the alkyloxy group consists of a propyl group bonded to the oxygen atom. When X is C₄ the alkyloxy group consists of a butyl group bonded to the oxygen atom. When X is C₅ the alkyloxy group consists of a pentyl group bonded to the oxygen atom. When X is C₆ the alkyloxy group consists of a hexyl group bonded to the oxygen atom.

“Monoalkylaxy” means that attached to a silicon atom is one alkyloxy group.

“Dialkyloxy” means that attached to a silicon atom are two alkyloxy groups.

“Trialkyloxy” means that attached to a silicon atom are three alkyloxy groups.

“Synthetic Liquor” or “Synthetic Spent Liquor” is a laboratory created liquid used for experimentation whose composition in respect to alumina, soda, and caustic corresponds with the liquor produced by recycling through the Bayer process.

“Bayer Liquor” is actual liquor that has run through a Bayer process in an industrial facility.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

In the Bayer process for manufacturing alumina, bauxite ore passes through a grinding stage and alumina, together with some impurities including silica, are dissolved in added liquor. The mixture then typically passes through a desilication stage where silica is deliberately precipitated as DSP to reduce the amount of silica in solution. The slurry is passed on to a digestion stage where any remaining reactive silica dissolves, thus again increasing the concentration of silica in solution which may subsequently form more DSP as the process conditions change. The liquor is later separated from undissolved solids, and alumina is recovered by precipitation as gibbsite. The spent liquor completes its circuit as it passes through a heat exchanger and back into the grinding stage. DSP scale accumulates throughout the Bayer process but particularly at the digestion stage and most particularly at or near the heat exchanger, where the recycled liquor passes through.

In at least one embodiment of the invention, the rate of formation of DSP on Bayer process equipment is reduced by pre-treating the surface of the equipment that will come into contact with Bayer liquor. In at least one embodiment of the invention, the rate of formation of DSP on Bayer process equipment is reduced by precisely dosing the scale reducing composition of matter.

Scale particles on process equipment surfaces such as vessel walls or pipes enhance the further formation of more scale. While some scale will “pioneer” formation on a clean surface, the rate of scale formation rapidly increases once some scale has already been “seeded” and functions as an anchor for further scale accumulation. As a result, a strategy for denying DSP scale any already seeded anchor points can result in a more effective inhibition of DSP scale formation while utilizing a smaller amount of anti-scaling material.

In the case of DSP formation in the Bayer process, the propensity of scale to accumulate on the walls of vessels or pipes is not simply dependent on the contents and conditions of the liquor, but also to the nature of the surface that liquor comes into contact with. By reducing the extent and time with which scale is allowed to persist on the surface walls, DSP accumulation can be severely reduced. As a result it is more effective to treat surfaces where DSP accumulates rather than already established accumulations of DSP scale.

In at least one embodiment the vessel walls are pre-treated with the anti-scaling composition before they come into contact with Bayer Process liquor. In at least one embodiment scale formations are treated in situ so as to reduce enhancing impact that undisturbed scale formation would have on the acceleration of scale formation rates. In art least one embodiment a fluid containing a DSP scale inhibiting composition but which lacks any (or any significant amount of) DSP forming material is passed through the some or all of the process equipment in a Bayer process circuit.

In at least one embodiment the composition is one or more of various types of silane-based products that can reduce the amount of DSP scale formed. In at least one embodiment the DSP inhibiting composition is one or more of those compositions disclosed in U.S. patent application Ser. Nos. 13/403,282, 13/035,124, and U.S. Pat. Nos. 8,282,834, 8,029,752, 5,415,782, and 5,314,626, and any combination thereof.

In at least one embodiment of the invention, an effective concentration of a silane-based small molecule product is added to some point or stage in the liquor circuit of the Bayer process, which minimizes or prevents the accumulation of DSP on vessels or equipment along the liquor circuit.

In at least one embodiment, the small molecule comprises the reaction product between an amine and at least one amine-reactive silane, the silicon of the silane can be monoalkyloxy, dialkyloxy, trialkyloxy or trihydroxy.

In at least one embodiment the small molecule is a reaction product between an amine-containing small molecule and an amine-reactive molecule containing at least one amine-reactive group per molecule and at least one —Si(OR)ₙ group per molecule, where n=1, 2, or 3, and R=H, C1-C12 Alkyl, Aryl, Na, K, Li, or NH₄, or a mixture of such reaction products.

In at least one embodiment the method for the reduction of aluminosilicate containing scale in a Bayer process comprises the steps of:

adding to a fluid in Bayer process equipment an aluminosilicate scale inhibiting amount of a composition comprising at least one small molecule, the at least one small molecule comprising of at least three components, one being an R₁ component, one being an R₂ component and one being an R₃ component, the components within the small molecule arranged according to the general formula:

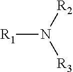

wherein:
(i) R₁ is selected from the group consisting of: H, alkyl, amine, structure (A) and structure (B);

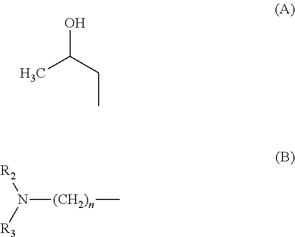

(ii) R₂ is independently selected from the group consisting of: H, alkyl, amine, G and E, and n is an integer from 2 to 6.

G being one item selected from the group consisting of: 3-glycidoxypropyltrimethoxysilane, 3-glycidoxypropyltrialkoxysilane, 3-glycidoxypropylalkyldialkoxysilane, 3-glycidoxypropyldialkylmonoalkoxysilane, 3-isocyanatopropyltrialkoxysilane, 3-isocyanatopropylalkyldialkoxysilane, 3-isocyanatopropyldialkylmonoalkoxysilane, 3-chloropropyltrialkoxysilane, 3-chloropropylalkyldialkoxysilane, and 3-chloropropyldialkylmonoalkoxysilane;

E being 2-ethylhexyl glycidyl ether, C₃-C₂₂ glycidyl ether, C₃-C₂₂ isocyanate, C₃-C₂₂ chloride, C₃-C₂₂ bromide, C₃-C₂₂ iodide, C₃-C₂₂ sulfate ester, C₃-C₂₂ phenolglycidyl ether, and any combination thereof,
(iii) R₃ is independently selected from the group consisting of: H, alkyl, amine, G and E.

In at least one embodiment the R₁ is independently selected from the group consisting of: monoisopropanol amine, ethylene diamine, diethylene triamine, tetraethylene pentamine, isophoronediamine, xylenediamine, bis(aminomethyl)cyclohexane, hexanediamine, C,C,C-trimethylhexanediamine, methylene bis(aminocyclohexane), saturated fatty amines, unsaturated fatty amines such as oleylamine and soyamine, N-fatty-1,3-propanediamine such as cocoalkylpropanediamine, oleylpropanediamine, dodecylpropanediamine, hydrogenized tallow alkylpropanediamine, and tallow alkylpropanediamine and any combination thereof.

In at least one embodiment said small molecule is selected from the group consisting of: (I), (II), (III), (IV), (V), (VI), (VII), (VIII), and (IX) as described in U.S. patent application Ser. No. 12/567,116.

In at least one embodiment the small molecule is selected from the group consisting of: (X) (XI), (XII), (XIII), (XIV), (XV), (XVI), (XVII), (XVIII), and (XIX) as described in U.S. patent application Ser. No. 12/567,116.

In at least one embodiment the small molecule is selected from the group consisting of: (XX), (XXI), and (XXII) as described in U.S. patent application Ser. No. 12/567,116.

In at least one embodiment the small molecule is selected from the group consisting of: (XXIII), (XXIV), (XXV), (XXVI), (XXVII), (XVIII), and (XIX) as described in U.S. patent application Ser. No. 12/567,116.

In at least one embodiment the small molecule is selected from the group consisting of: (XXVIII), (XXIX), (XXX), (XXXI), (XXXII) and combinations thereof as described in U.S. patent application Ser. No. 12/567,116.

In at least one embodiment the small molecule is selected from the group consisting of: (XXXIII), (XXXIV), (XXXV), (XXXVI), (XXXVII), (XXXVIII), (XXXIX), (XL), (XLI), and (XLII) as described in U.S. patent application Ser. No. 12/567,116.

In at least one embodiment the small molecule is selected from the group consisting of: (XLIII), (XLIV), (XLV), (XLVI), (XLVII), (XLVIII), (XLIX), (L), (LI), and (LII) as described in U.S. patent application Ser. No. 12/567,116.

In at least one embodiment the small molecule is selected from the group consisting of: (LIII), (LIV), and (LV) as described in U.S. patent application Ser. No. 12/567,116.

In at least one embodiment the small molecule is selected from the group consisting of: (LVI), (LVII), (LVIII), (LIX), (LX), (LI), and (LII) as described in U.S. patent application Ser. No. 12/567,116.

In at least one embodiment the small molecule is selected from the group consisting of: (LXI), (LXII), (LXIII), and (LXIV) as described in U.S. patent application Ser. No. 12/567,116.

In at least one embodiment the small molecule is present in a solution in an amount ranging from about 0.01 to about 100 wt %. The composition may further comprise one item selected from the list consisting of: amines, activators, antifoaming agents, co-absorbents, corrosion inhibitors, coloring agents, and any combination thereof. The composition may comprise a solvent, the solvent is selected from the group consisting of: water, alcohols, polyols, other industrial solvents, organic solvents, and any combination thereof. The components may be isolated from the reaction in the form of a solid, precipitate, salt and/or crystalline material in pH's ranging from 0 to 14.

Although some of these small molecules have been mentioned in various references, their effectiveness in reducing Bayer Process scale was wholly unexpected.

Some places where they have been mentioned include: scientific paper: Ethylenediamine attached to silica as an efficient, reusable nanocatalyst for the addition of nitromethane to cyclopentenone By DeOliveira, Edimar; Prado, Alexandre G. S., Journal of Molecular Catalysis A: Chemical (2007), 271(1-2), 6369, international patent application WO 2003002057 A2, and Chinese patent application CN 101747361.

The effectiveness of these small molecules was unexpected as the prior art teaches that only high molecular weight polymers are effective. Polymer effectiveness was presumed to depend on their hydrophobic nature and their size. This was confirmed by the fact that cross-linked polymers are even more effective than single chain polymers. As a result it was assumed that small molecules only serve as building blocks for these polymers and are not effective in their own right. (WO 2008/045677 [0030]). Furthermore, the scientific literature states “small molecules containing” . . . “[an] Si—O₃ grouping are not effective in preventing sodalite scaling” . . . because . . . “[t]he bulky group” . . . “is essential [in] keeping the molecule from being incorporated into the growing sodalite.” Page 57¶9 Light Metals 2008, (2008). However it has recently been discovered that in fact, as further explained in the provided examples, small molecules such as those described herein are actually effective at reducing DSP scale.

It is believed that there are at least three advantages to using a small molecule-based inhibitor as opposed to a polymeric inhibitor with multiple repeating units of silane and hydrophobes. A first advantage is that the smaller molecular weight of the product means that there are a larger number of active, inhibiting moieties available around the DSP seed crystal sites at the DSP formation stage. A second advantage is that the lower molecular weight allows for an increased rate of diffusion of the inhibitor, which in turn favors fast attachment of the inhibitor molecules onto DSP seed crystals. A third advantage is that the lower molecular weight avoids high product viscosity and so makes handling and injection into the Bayer process stream more convenient and effective.

### EXAMPLES

The foregoing may be better understood by reference to the following examples, which are presented for purposes of illustration and are not intended to limit the scope of the invention.

Polypropylene bottles and a temperature controlled rotary water bath were used for the isothermal, batch desilication experiments. Samples of DSP solids (0.5 g) were added to spent liquor (˜50 mL) to make a slurry. DSP scale inhibitor (I) being a dilute caustic solution of a small molecule comprised of the reaction products of tetraethylenepentamine, GPS and 2-ethylhexyl glycidyl ether, was then added at various concentrations (50 μL, 100 μL and 200 μL) and these treatments and were designated as low, medium and high dose. A further slurry sample was not treated with inhibitor and was used as an undosed control sample.

To a bulk sample of plant spent Bayer liquor (˜2 litres) at room temperature, a small volume of concentration sodium metasilicate solution was added to raise the initial silica concentration by approximately 0.8-1.0 g/L as SiO₂. This “spiked” liquor was then used for subsequent testing.

DSP Formation Test

Samples of the spiked liquor (200 mL) were each placed into 250 mL Nalgene bottles and dosed with the “pre-treated” DSP slurry (10 mL of slurry per bottle). Effectively each sample had 0.1 g of DSP solid per bottle added as a “seed” source. Additionally, samples with no DSP slurry added (liquor only) were also included in this test. Duplicate samples of each treatment were used. The bottles were then placed in a rotating water bath pre-heated to 95° C. and rotated for a period of 4 hours. After heating for 4 hours the bottles were removed from the water bath and the solids were filtered (45 μm paper) and washed with water, then air-dried overnight. Inhibition of precipitation was measured by the mass of solids obtained from the “pre-treated” DSP compared to control sample where an undosed DSP slurry was added to the samples. The “liquor only” sample (no DSP seed added) was included for comparison.

Results

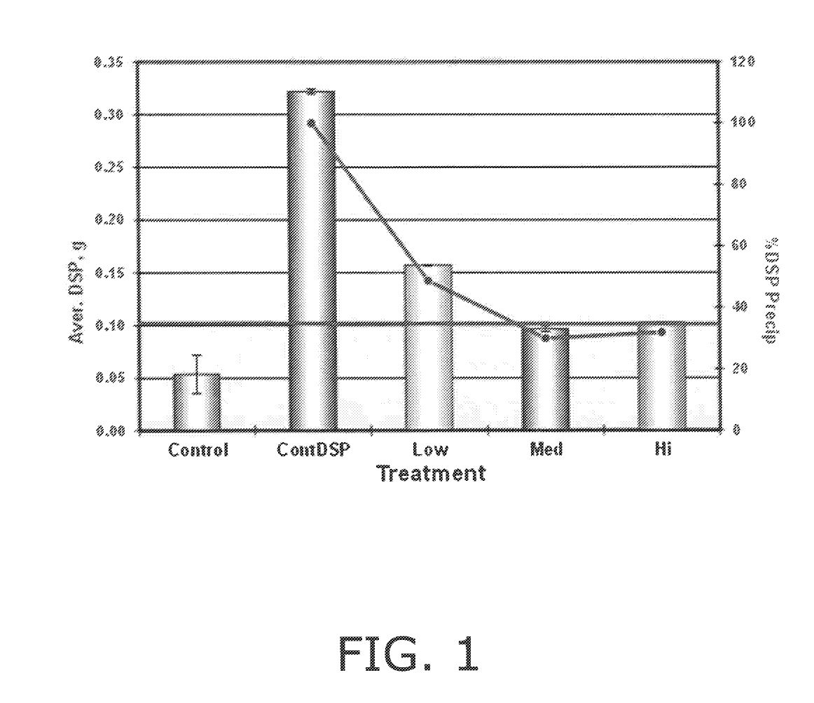

Average mass of DSP precipitated from the various treatments are shown in FIG. 1. Average data of duplicate samples are shown with error bars indicating standard deviation. Without DSP seed, the “liquor only” samples (designated as “control” in FIG. 1) precipitated approximately 0.05 g of DSP under the test conditions. By comparison the impact of adding 0.1 g of DSP seed resulted in a total mass of more than 0.30 g—a net precipitation of >0.2 g of DSP from the liquor. This result indicates how the presence of solid DSP enhances the formation of DSP from solution under such conditions.

By comparison, pre-treatment of the solid DSP prior to seeding substantially reduces this impact as noted in the resultant mass obtained from the pre-treated samples. In the cases of the medium and high pre-treatments, the mass of DSP recovered was equivalent to the amount of solids initially added, indicating that no further DSP precipitation occurred.

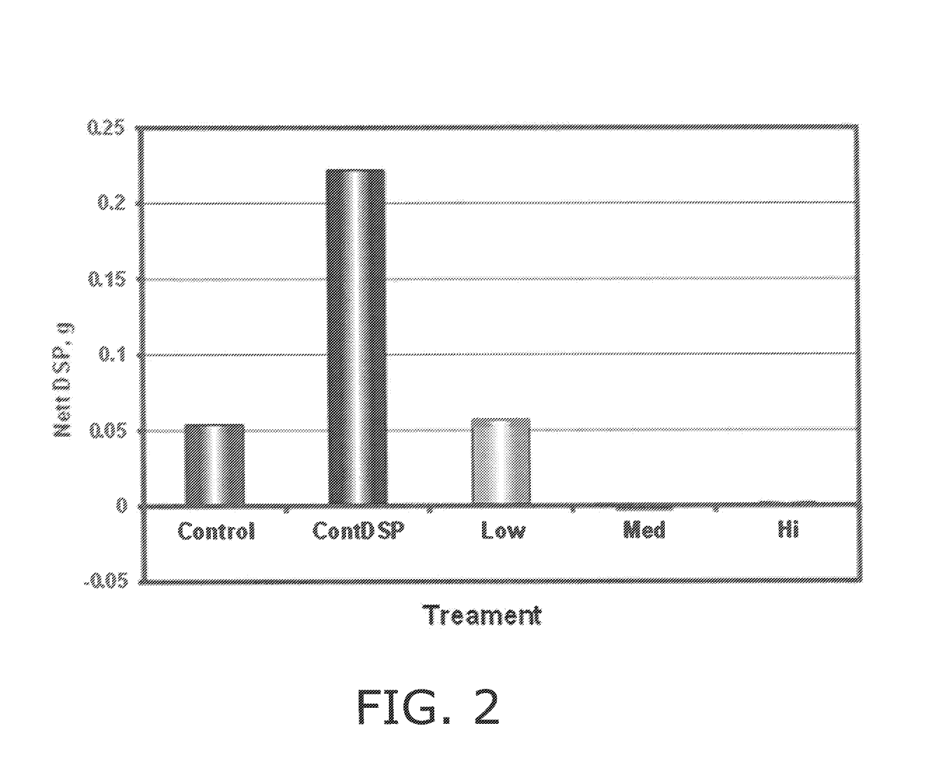

FIG. 1 illustrates the average total mass of solids recovered (bars, left hand axis) plotted as a function of treatment. The same data, plotted as a percentage of the mass precipitated from the “un-treated” DSP control sample is also plotted (line, right hand axis). DSP seed initially added (0.1 g per bottle) is indicated by the horizontal line. The effectiveness of the “pre-treatment” of DSP in controlling the further precipitation of DSP is shown more clearly when replotting FIG. 1 with net DSP mass (the mass of DSP precipitated from the liquor) as a function of treatment is plotted—as illustrated in FIG. 2

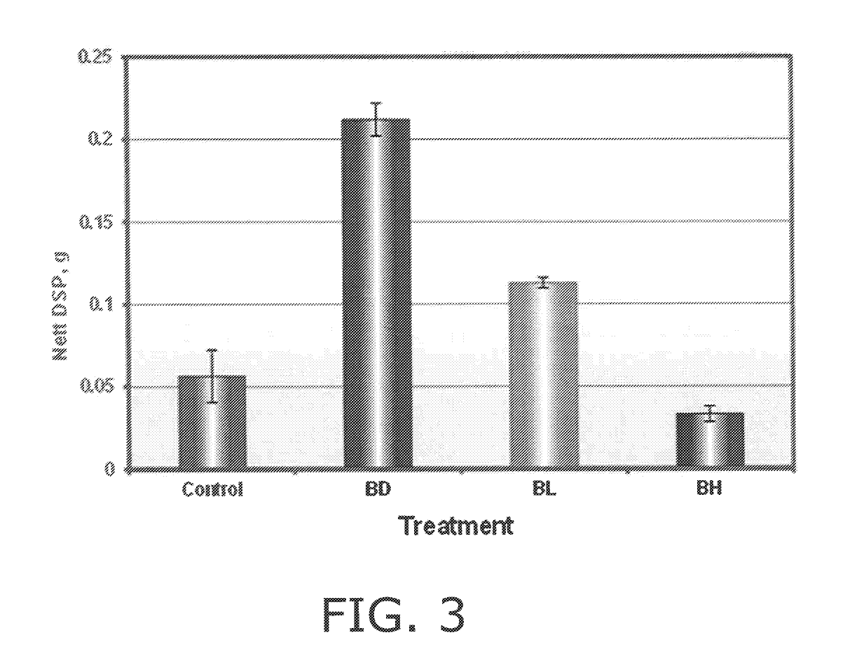

FIG. 3 illustrates a second example of the invention. The washed and dried DSP solids that resulted from the precipitation tests were subsequently used as “pre-treated” DSP solids in a further precipitation bottle test. The solids from the seeded control sample (no inhibitor added) was used in one set of bottles while separately, the DSP subjected to low pre-treatment dose and high pre-treatment dose were used as seed material. A mass of 0.1 g of solids per bottle was employed and was added as a dry powder to individual bottles. The method outlined in the DSP formation test as described in example 1 was used. Duplicate samples were again used in all treatments.

As can be seen in FIG. 3 the results of this test indicate the reduction of DSP mass precipitated in the presence of the “pre-treated” DSP. The mass of DSP precipitated is plotted as net DSP mass precipitated—that is, total mass collected minus the mass of DSP added as seed. Net mass of DSP recovered (bars) is plotted as a function of treatment. Control—no DSP added, BD—“untreated” DSP; BL—DSP “pre-treated” with low dose of inhibitor; & BH—DSP “pre-treated” with high dose of inhibitor. DSP added: 0.1 g per bottle.

A reduction in DSP precipitated in the seeded samples where pre-treated DSP was used is again observed. In this case, this is despite the fact that the solids were thoroughly washed and dried after the pre-treatment and prior to use in this test. This indicates that the pre-treatment of DSP solids is robust and that further conditioning or washing will not affect the impact of pre-treatment. In effect, the DSP becomes substantially less effective as a seed source. As a result, pre-treated seed is unlikely to promote the further deposition of DSP as scale.

While this invention may be embodied in many different forms, there described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and incorporated herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for the reduction of aluminosilicate containing scale in a Bayer process comprising the steps of:
contacting at least a portion of at least one surface of at least one piece of Bayer process equipment with a scale inhibiting composition of matter in the absence of any liquor.

2. The method of claim 1 in which the composition is further added after Bayer liquor contacts the surface, wherein the compositions is dosed to inhibit the formation of scale anchors, the dosage being lower than and more effective at inhibiting scale formation than a larger dosage of the same composition which was not contacted to the surface in the absence of liquor.

3. The method of claim 1 in which the composition is a non-polymeric molecule having at least one Si(OR)n group where each R is independently selected from the list consisting of: C₁-C₁₂, alkyl, aryl, Na, K, Li, or NH₄ and n=1, 2, or 3.

4. The method of claim 1 wherein the composition is a non-polymeric molecule according to the formula: 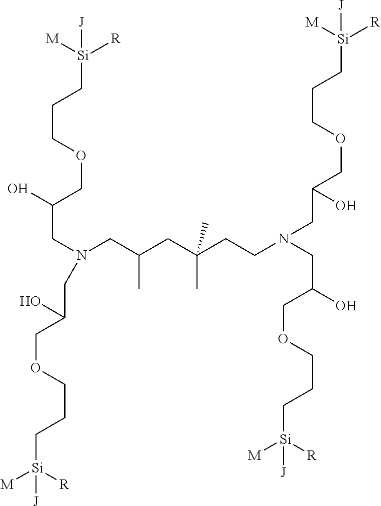
wherein M, J, and R groups are each one selected from the list consisting of C₁-C₆ alkyloxy, hydrogen, hydroxide, or C₁-C₆ alkyl groups, and at least one of M, J, and R are an alkyloxy group.

5. The method of claim 1 in which the composition comprises at least one small molecule, the at least one small molecule comprising of at least three components, one being an R₁ component, one being an R₂ component and one being an R₃ component, the components within the small molecule arranged according to the general formula: 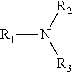
wherein:
(i) R₁ is selected from the group consisting of: H, alkyl, amine, structure (A) and structure (B); 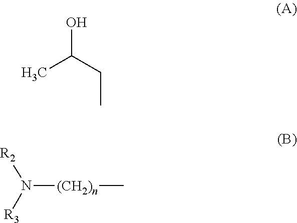
(ii) R₂ is independently selected from the group consisting of: H, alkyl, amine, G and E, and n is an integer from 2 to 6.
G being one item selected from the group consisting of: 3-glycidoxypropyltrimethoxysilane, 3-glycidoxypropyltrialkoxysilane, 3-glycidoxypropylalkyldialkoxysilane, 3-glycidoxypropyldialkylmonoalkoxysilane, 3-isocyanatopropyltrialkoxysilane, 3-isocyanatopropylalkyldialkoxysilane, 3-isocyanatopropyldialkylmonoalkoxysilane, 3-chloropropyltrialkoxysilane, 3-chloropropylalkyldialkoxysilane, and 3-chloropropyldialkylmonoalkoxysilane;
E being 2-ethylhexyl glycidyl ether, C₃-C₂₂ glycidyl ether, C₃-C₂₂ isocyanate, C₃-C₂₂ chloride, C₃-C₂₂ bromide, C₃-C₂₂ iodide, C₃-C₂₂ sulfate ester, C₃-C₂₂ phenolglycidyl ether, and any combination thereof,
(iii) R₃ is independently selected from the group consisting of: H, alkyl, amine, G and E.
